(19) United States
(12) Patent Application Publication
(10) Pub. No.: US 2014/0348034 A1
(43) Pub. Date: Nov. 27, 2014

(54) SYSTEMS AND METHODS FOR GROUP COMMUNICATION IN NOISY ENVIRONMENTS

(71) Applicant: MOTOROLA SOLUTIONS, INC., Schaumburg, IL (US)

(72) Inventors: PAVEL LIVSHITS, MODIYIN (IL); ITZHAK AVAYU, MEVASSERET TZION (IL); NISSIM GEAN, NETANUZ (IL)

(73) Assignee: MOTOROLA SOLUTIONS, INC., Schaumburg, IL (US)

(21) Appl. No.: 13/901,019

(22) Filed: May 23, 2013

(51) Int. Cl. H04L 5/16

(52) U.S. Cl. CPC H04L 5/16
USPC 370/278

(57) ABSTRACT

A method, a system, and a network include combining communications from a plurality of subscribers providing a full-duplex communication channel therebetween; detecting noise on the full-duplex communication channel above a predetermined threshold; and selectively enabling a special half-duplex mode on one or more of the plurality of subscribers responsive to the noise, wherein the special half-duplex mode comprises a push-to-talk mode whereby a subscriber has to enable communications via push-to-talk while communicating on the full-duplex communication channel. The method, system, and network define a special half-duplex mode whereby participants are allowed to communicate via push-to-talk, but have their associated lines suppressed to remove noise from the full-duplex communication channel.

### BACKGROUND OF THE INVENTION

In group communication sessions or conference calls, a plurality of users are communicatively coupled for exchange of information therebetween. Such group communication sessions can be half-duplex (one direction of communication at a time) or full-duplex (both directions of communication at a time). The group communication sessions can be over wireless networks, wired networks, or a combination or mixture thereof. An exemplary application of group communication sessions is in the context of public safety for mission critical communications. Conventional public safety communication networks utilize various wireless techniques such as Land Mobile Radio (LMR) which typically employs half-duplex. Public safety communication networks are moving towards cellular broadband systems with allow full-duplex conference systems allowing for more natural communications. In these systems (and all full-duplex conference systems), all the microphones are ready to capture sound of all participants unless each participant mutes their microphone. This can be a severe problem if some of the participants are in noisy environments. The problem can be so severe that it prevents participants from barging in or even regular contributions. Full-duplex conference systems, although improve communication in many ways, are challenging in mission critical situations and the like.

Accordingly, there is a need for systems and methods for group communications in noisy environments such as in mission critical situations and the like.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a communication network in accordance with some embodiments.

FIG. 2 is a block diagram of the server in the communication network of FIG. 1 in accordance with some embodiments.

FIG. 3 is a block diagram of the user equipment in the communication network of FIG. 1 in accordance with some embodiments.

FIG. 4 is a functional block diagram of an interconnect system for bridging two or more subscribers on an interconnect call in accordance with some embodiments.

FIG. 5 is a flowchart of a noise suppression method in group communication systems and methods in accordance with some embodiments.

FIG. 6 is a flowchart of a leader imposed method in group communication systems and methods in accordance with some embodiments.

FIG. 7 is a flowchart of a group communication method with noise suppression in accordance with some embodiments.

FIG. 8 is a flowchart of a noise detection method for use with the group communication method of FIG. 7 in accordance with some embodiments.

FIG. 9 is a flowchart of a selective enabling method for use with the group communication method in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In various exemplary embodiments, systems and methods for group communications in noisy environments such as in mission critical situations related to public safety are described. Specifically, an exemplary objective is to reduce the disadvantages of full-duplex communications while keeping is advantages. In an exemplary embodiment, a method includes combining communications from a plurality of subscribers providing a full-duplex communication channel therebetween; detecting noise on the full-duplex communication channel above a predetermined threshold; and selectively enabling a special half-duplex mode on one or more of the plurality of subscribers responsive to the noise, wherein the special half-duplex mode comprises a push-to-talk mode whereby a subscriber has to enable communications via push-to-talk while communicating on the full-duplex communication channel.

In another exemplary embodiment, a system includes a network interface communicatively coupled to a plurality of subscribers; a processor communicatively coupled to the network interface; and memory storing instructions that, when executed, cause the processor to: combine communications from the plurality of subscribers providing a full-duplex communication channel therebetween; detect noise on the full-duplex communication channel above a predetermined threshold; and selectively enable a special half-duplex mode on one or more of the plurality of subscribers responsive to the detecting noise, wherein the special half-duplex mode comprises a push-to-talk mode whereby a subscriber has to enable communications via push-to-talk while communicating on the full-duplex communication channel.

In yet another exemplary embodiment, a network includes a plurality of user equipment each associated with a subscriber; and an interconnect system communicatively coupled to each of the plurality of user equipment; wherein each of the plurality of user equipment is configured to participate in a full-duplex communication channel through the interconnect system; and wherein the interconnect system is configured to: combine communications from the plurality of user equipment providing the full-duplex communication channel therebetween; detect noise on the full-duplex communication channel above a predetermined threshold or a request message from one of the plurality of user equipment; and selectively enable a special half-duplex mode on one or more of the plurality of subscribers responsive to detecting noise or the request message, wherein the special half-duplex mode comprises a push-to-talk mode hereby a subscriber has to enable communications while communicating on the full-duplex communication channel.

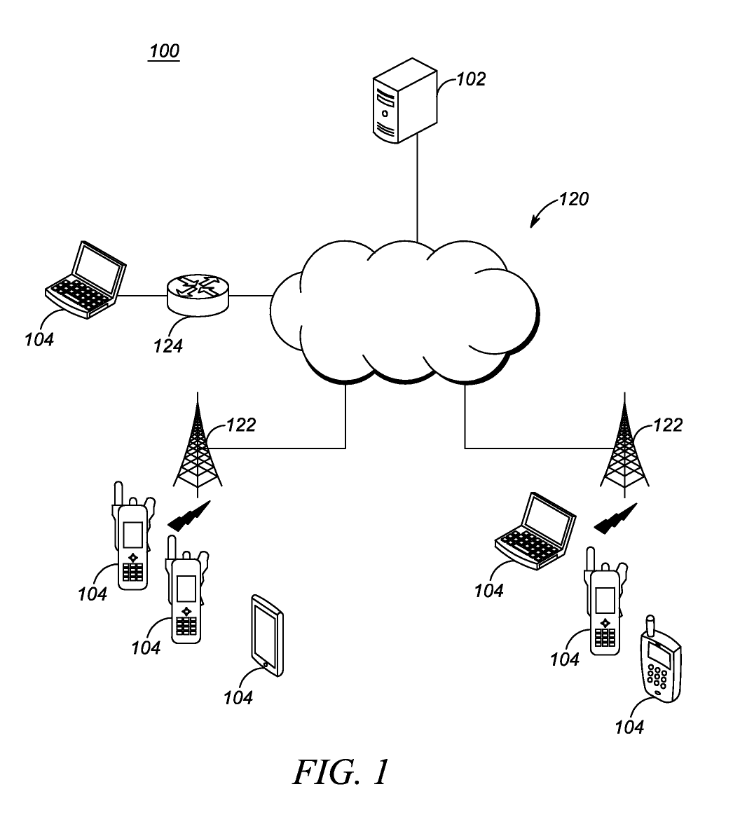

FIG. 1 is a block diagram of a communication system 100 in accordance with some embodiments. The communication system 100 includes a server 102 acting as a bridge and a plurality of user equipment 104 communicatively coupled to the server 102 via a network 120. The server 102 can be a general purpose computing device, a conference bridge, a Voice over Internet Protocol (VoIP) server, or the like. The user equipment 104 can include mobile devices, smart phones, radios, tablets, laptops, desktops, cordless phones, wired phones, or any general computing device capable of two-way communications. In an exemplary embodiment, the communications between the user equipment 104 can be audio. In another exemplary embodiment, the communications between the user equipment 104 can be audio and/or video.

The network 120 can be a combination of various networks communicatively coupled therebetween to form a full-duplex link between the user equipment 104 and the server 102. For example, the user equipment 104 can be wirelessly connected to a wireless network formed by one or more access points 122. The access points 122 can be base stations, cell towers, cell sites, evolved node B, wireless local area network (WLAN) access points such as providing IEEE 802.11 communications, cordless phone bases, etc. In addition to wireless connectivity, the user equipment 104 can also connect via a wired connection such as through a router 124. The server 102 can also connect to the network 120 wirelessly and/or wired.

Portions of the network 120 can include the Internet as well as other wide area networks (WANs), local area networks (LANs), virtual private networks (VPNs), and the like. The communication system 100 and the network 120 can include any type of network such as, without limitation, VoIP, Long Term Evolution (LTE), 3G/4G wireless, Terrestrial Trunked Radio (TETRA), Land Mobile Radio (LMR), landline communications, and combinations thereof. Those of ordinary skill in the art will appreciate the foregoing group communication systems and methods contemplate use with any many-to-many communication technology, protocol, equipment, etc.

In the group communications systems and methods, the subscribers associated with each of the user equipment 104 are participating in a group call which is full-duplex. Here, the server 102, acting as a bridge, combines communication streams from each of the user equipment 104 for broadcast therebetween. In an exemplary embodiment, the communication system 100 is used amongst public safety subscribers and the group call is a mission critical call. Of note, each of the user equipment 104 has associated ambient noise that is combined by the server 102 presenting a combination of noise associated with each of the user equipment 104 as well as information such as verbal communication.

The communication system 100 can include a plurality of user equipment each associated with a subscriber; and an interconnect system communicatively coupled to each of the plurality of user equipment. Each of the plurality of user equipment is configured to participate in a full-duplex communication channel through the interconnect system. The interconnect system is configured to: combine communications from the plurality of user equipment providing the full-duplex communication channel therebetween; detect noise on the full-duplex communication channel above a predetermined threshold or a request message from one of the plurality of user equipment; and selectively enable a special half-duplex mode on one or more of the plurality of subscribers responsive to detecting noise or the request message, wherein the special half-duplex mode comprises a push-to-talk mode hereby a subscriber has to enable communications via push-to-talk while communicating on the full-duplex communication channel.

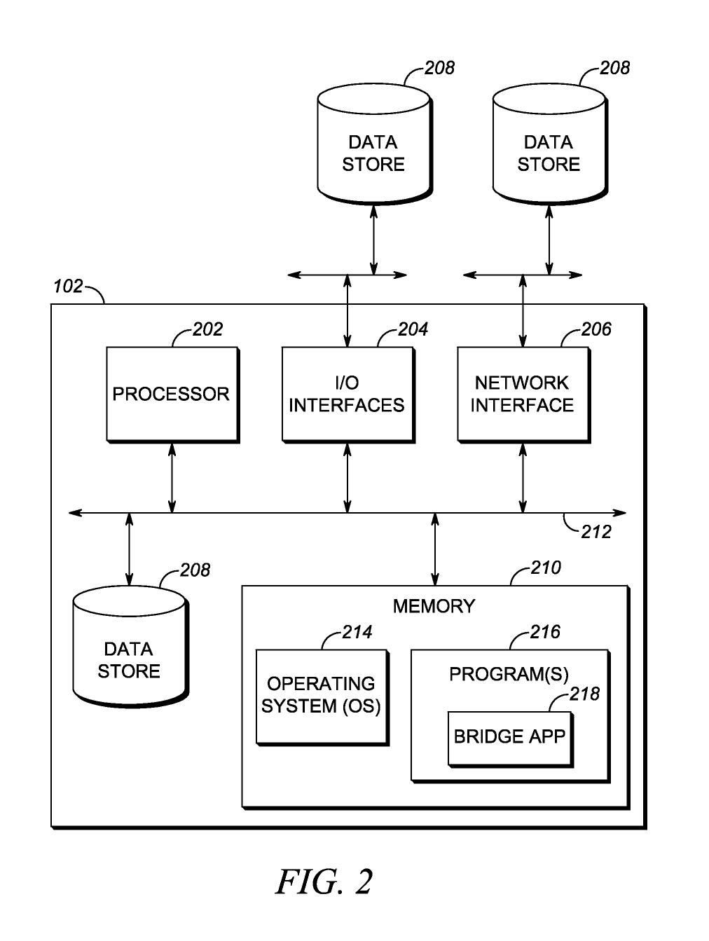

FIG. 2 is a block diagram of the server 102 in the communication system 100 in accordance with some embodiments. The server 102 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 102 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a central processing unit (CPU), an auxiliary processor among several processors associated with the server 102, a semiconductor-based microprocessor (in the form of a microchip or chip set), or generally any device for executing software instructions. When the server 102 is in operation, the processor 202 is configured to execute software stored within the memory 210, to communicate data to and from the memory 210, and to generally control operations of the server 102 pursuant to the software instructions. The I/O interfaces 204 may be used to receive user input from and/or for providing system output to one or more devices or components. User input may be provided via, for example, a keyboard, touch pad, and/or a mouse. System output may be provided via a display device and a printer (not shown). I/O interfaces 204 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 206 may be used to enable the server 102 to communicate on a network, such as the network 120 and the like, etc. The network interface 206 may include, for example, an Ethernet card or adapter (e.g., 10BaseT, Fast Ethernet, Gigabit Ethernet, 10GbE) or a wireless local area network (WLAN) card or adapter (e.g., 802.11a/b/g/n). The network interface 206 may include address, control, and/or data connections to enable appropriate communications on the network. The data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 102 such as, for example, an internal hard drive connected to the local interface 212 in the server 102. Additionally in another embodiment, the data store 208 may be located external to the server 102 such as, for example, an external hard drive connected to the I/O interfaces 204 (e.g., SCSI or USB connection). In a further embodiment, the data store 208 may be connected to the server 102 through a network, such as, for example, a network attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another, but can be accessed by the processor 202. The software in memory 210 may include one or more software programs, each of which includes an ordered listing of executable instructions for implementing logical functions. The software in the memory 210 includes a suitable operating system (0/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. For example, the programs 216 can include a bridge application 218 for interfacing with the user equipment 104 and providing a group call therebetween.

In an exemplary embodiment, the bridge application 218 includes instructions that, when executed, cause the processor 202 to combine communications from the plurality of subscribers providing a full-duplex communication channel therebetween; detect noise on the full-duplex communication channel above a predetermined threshold; and selectively enable a special half-duplex mode on one or more of the plurality of subscribers responsive to the detecting noise, wherein the special half-duplex mode comprises a push-to-talk mode whereby a subscriber has to enable communications via push-to-talk while communicating on the full-duplex communication channel.

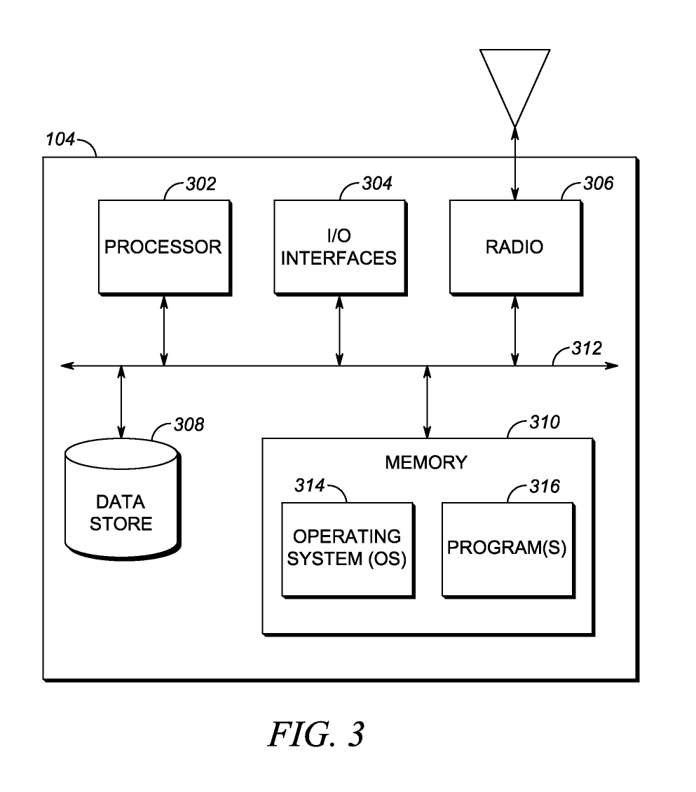

FIG. 3 is a block diagram of the user equipment 104 in the communication system 100 in accordance with some embodiments. The user equipment 104 can include, without limitation, a smart phone, a radio, a tablet, a laptop, an ultra-book, a net book, or any other portable communication device. The user equipment 104 can be a digital device that, in terms of hardware architecture, generally includes a processor 302, input/output (I/O) interfaces 304, a radio 306, a data store 308, and memory 310. It should be appreciated by those of ordinary skill in the art that FIG. 3 depicts the user equipment 104 in an oversimplified manner, and a practical embodiment can include additional components and suitably configured processing logic to support known or conventional operating features that are not described in detail herein. The components (302, 304, 306, 308, and 310) are communicatively coupled via a local interface 312. The local interface 312 can be, for example but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a central processing unit (CPU), an auxiliary processor among several processors associated with the user equipment 104, a semiconductor-based microprocessor (in the form of a microchip or chip set), or generally any device for executing software instructions. When the user equipment 104 is in operation, the processor 302 is configured to execute software stored within the memory 310, to communicate data to and from the memory 310, and to generally control operations of the user equipment 104 pursuant to the software instructions. In an exemplary embodiment, the processor 302 may include a mobile optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, and the like. The I/O interfaces 304 can also include, for example, a serial port, a parallel port, a small computer system interface (SCSI), an infrared (IR) interface, a radio frequency (RF) interface, a universal serial bus (USB) interface, and the like. The I/O interfaces 304 can include a graphical user interface (GUI) that enables a user to interact with the user equipment 104.

The radio 306 enables wireless communication to an external access device or network. Any number of suitable wireless data communication protocols, techniques, or methodologies can be supported by the radio 306, including, without limitation: RF; LMR; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; LTE; cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

The data store 308 can be used to store data. The data store 308 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 can incorporate electronic, magnetic, optical, and/or other types of storage media. The memory 310 can include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 can have a distributed architecture, where various components are situated remotely from one another, but can be accessed by the processor 302.

The software in memory 310 may include one or more software programs, each of which includes an ordered listing of executable instructions for implementing logical functions. The software in the memory 310 includes a suitable operating system (O/S) 314 and one or more programs 316. The operating system 314 essentially controls the execution of other computer programs, such as the one or more programs 316, and provides scheduling, input-output control, file and data management, memory management, and communication control and related services. The one or more programs 316 may be configured to implement the various processes, algorithms, methods, techniques, etc. described herein. For example, the programs 316 can include a communications application for having a group call with other subscribers in the communication system 100.

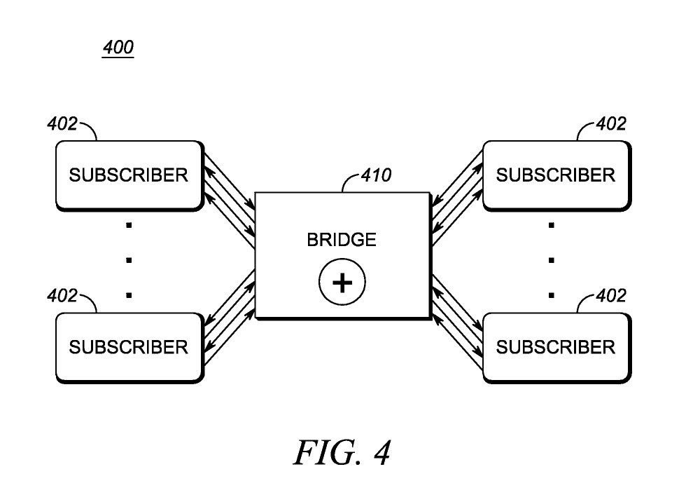

FIG. 4 is a functional block diagram of an interconnect system 400 for bridging two or more subscribers 402 on an interconnect call in accordance with some embodiments. The interconnect system 400 includes a bridge 410 communicatively coupled to the two or more subscribers 402. In an exemplary embodiment, the interconnect system 400 can be formed in the communication system 100 with the bridge 410 as the server 102 and the two or more subscribers 402 as the user equipment 104. Other implementations are also contemplated for the interconnect system 400. In an exemplary embodiment, the interconnect system 400 is a telecommunication system where the two or more subscribers 402 participate in the interconnect call (which can also be referred to as a conference call, a group call, a conference bridge, a teleconference, etc.). In order to manage this type of call between the two or more subscribers 402, a bridge concept is used via the bridge 410. This bridge functionality allows multi party calls. The bridge 410 receives the audio streams from all the subscribers 402, adds all the audio or other communications (e.g. video) from all the subscribers 402 and, sends it forth to all the subscribers 402. Before sending the packets to each of the subscribers 402, the voice stream that originated in a particular subscriber 402 must be removed by the bridge 410 in order to avoid unwanted echo.

In the communication system 100 and the interconnect system 400, group communications systems and methods in noisy environments are provided. To support mission critical communications, even under adverse conditions, the group communications systems and methods support a special half-duplex mode concurrently with a full-duplex mode. The special half-duplex mode causes a microphone for selected parties to be muted by default, with a push-to-talk (PTT) button to over-ride the muting. For example, the PTT button may be required to remain enabled or pressed as long as the selected party wishes to communicate. One or more subscribers can be in the special half-duplex mode while the remaining subscribers are in a full-duplex mode. In an exemplary embodiment, the special half-duplex mode can be activated based on background noise levels such that the bridge can move or request selected participants (based on background noise levels) enter the special half-duplex mode, so that they do not impact group communications. In another exemplary embodiment, a call leader (or privileged participant) can force all participants the special half-duplex mode.

The special half-duplex mode in a full-duplex system can be implemented in the central conference bridge which has access to all the participant inputs and outputs. For example, the special half-duplex mode can be implemented in the server 102 and/or in the bridge 410. All of the user equipment 104 and/or the subscribers 402 can be in full-duplex communications with selected user equipment 104 and/or subscribers 402 in the special half-duplex mode. For example, user equipment 104 and/or subscribers 402 with excessive background noise can be automatically muted (e.g. at the server 102 and/or in the bridge 410) such that their output is not added to the full-duplex communications unless a PTT command or message is received. In another exemplary embodiment, leader demanded muting (special half-duplex mode) of some or all conference call participants can be based on manual commands such as from the leader, incident commander, etc.

The communication system 100 and the interconnect system 400 can include a defined a set of rules in order to conduct in efficient manner multi party full duplex conversations, which would allow addressing several cases of interference into the conference call, as in a mission critical situation. For example, the set of rules can be implemented via a set of defined messages exchanged between the server 102 and the user equipment 104 or between the bridge 410 and the subscribers 402. The messages may be routed in one or more of the following ways: (1) from a particular device participating in a full duplex call to the other devices; (2) from the communication bridge to any or all the devices; and/or (3) from any device to the communication bridge. The messages are transited by the communication devices (i.e. the user equipment 104, the subscribers 402, etc.) using mechanisms specific to each communication protocol in use. For example, this can include using a signaling channel, existing in the specific communication protocol, using an out or in band signal in the voice channel or any other available data communication method available in the specific application.

With the rules and messages, subscribers can participate in full-duplex communications while selected subscribers can be asked or forced into the special half-duplex mode. As such, the systems and methods include a full-duplex mode for one or more subscribers and optionally a special half-duplex mode for one or more subscribers on the same call. A communication device can the special half-duplex mode of operation by one of the following ways: (1) a message from subscribers (e.g. commander, leader, etc.) to the bridge requesting that other participants enter this special half-duplex mode; and/or (2) the bridge requests one or more devices enter the special half-duplex mode such as based on noise. In an exemplary embodiment, the bridge can request or force a device into the special half-duplex mode. In the case of a request, the bridge can present a subscriber with a request to enter the special half-duplex mode in which the subscriber can accept or decline. In the special half-duplex mode, a subscriber can still communicate so long as the subscriber enables a PTT message to the bridge such as via a button or command at the subscriber's device.

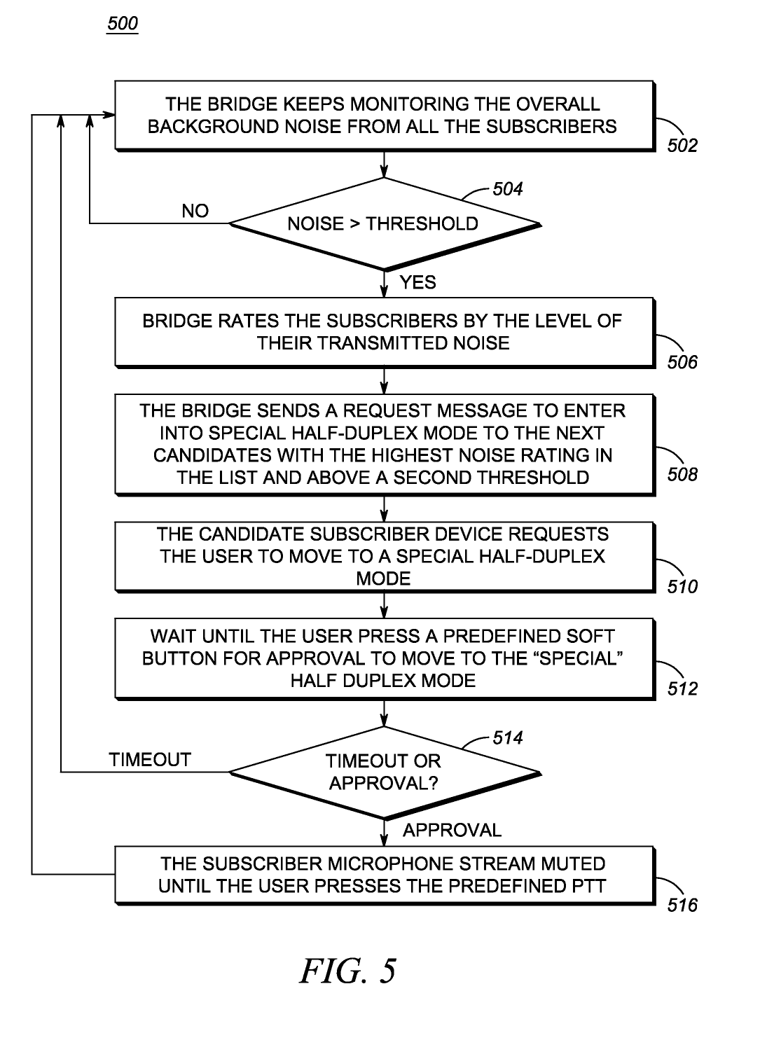

FIG. 5 is a flowchart of a noise suppression method 500 in group communication systems and methods in accordance with some embodiments. The noise suppression method 500 contemplates operation with the communication system 100, the interconnect system 400, and the like. In an exemplary embodiment, the noise suppression method 500 can be implemented by the server 102, the bridge 410, and the like. The bridge keeps monitoring the overall background noise from all the subscribers (step 502). In the communication system 100 and the interconnect system 400, the server 102 and the bridge 410 are communicatively coupled to each of the subscribers (i.e., the user equipment 104 and the subscribers 402). The bridge function in the noise suppression method 500 receives all of the communications from each subscriber and combines them together for an output to each subscriber which is a full-duplex communication channel. For a particular output of the full-duplex communication channel, a receiving subscriber can receive all communications from all other subscribers with the receiving subscriber's communications removed by the bridge to avoid echo.

Since the bridge receives all communications from all subscribers, the bridge can monitor the overall background noise on the full-duplex communication channel. As described herein, the noise is anything that is not actual communications on the full-duplex communication channel such as background noises, wind, sirens, speech in the background not meant for the full-duplex communication channel, rain, or any other communications in the background which are not meant for the full-duplex communication channel. The bridge can use any existing noise determination algorithm such as monitoring for sound outside of human speech frequencies, etc. The bridge has a predetermined noise threshold which is an amount of noise over which the full-duplex communication channel has difficulty for the individual subscribers to communicate. If the monitored noise is below the predetermined threshold for all subscribers (step 504), the noise suppression method 500 continues at step 502.

If the monitored noise is above or equal to the predetermined threshold for all subscribers (step 504), the bridge rates the subscribers by the level of their transmitted noise (step 506). Again, the bridge sees if subscriber individually and can determine each subscriber's contribution to the noise on the full-duplex communication channel. Here, the bridge can list each of the subscribers according to their noise level. The bridge sends a request message to enter into a special half-duplex mode to the next candidates with the highest noise rating in the list and above a second threshold (step 508). Here, the request message is for the subscriber candidates to enter the special half-duplex mode whereby the subscriber has to enable communications via push-to-talk while communicating on the full-duplex communication channel, otherwise the subscriber is muted. For example, to enable communications, the subscriber may have to depress (and maintain pressing) a PTT button or the like while communicating. Once the PTT button is released, the special half-duplex mode may once again block the subscriber's line from being added to the full-duplex communication channel. Once the request message is sent, the bridge removes the candidate from the list.

The candidate subscriber device requests the user to move to the special half-duplex mode (step 510). Here, the candidate subscriber device receives the request message and presents a request to the user or subscriber to enable the special half-duplex mode. This can include a pop-up notification on the user equipment 104 or some other indicia such as audio only heard by the candidate subscriber. The noise suppression method 500 waits until the user presses a predefined soft button or the like for approval to move to the special half-duplex mode (step 512). The noise suppression method 500 either receives a timeout from waiting or an approval from the user (step 514).

If the noise suppression method 500 receives a timeout, i.e. the user does not enter the special half-duplex mode (step 514), the noise suppression method 500 returns to step 502 and can request other users to enter the special half-duplex mode to decrease the noise on the full-duplex communication channel. If the noise suppression method 500 receives an approval (step 514), the subscriber microphone stream muted until the user presses the predefined PTT (step 516), and the noise suppression method 500 returns to step 502. The muting of the microphone stream can be done either in the subscriber itself or in the bridge with messages between the subscriber and bridge. For example, the user, in the special half-duplex mode, can still communicate on the full-duplex communication channel through enabling a PTT mode whereby the user signals to the bridge a desire to communicate and turn off the muting.

In another exemplary embodiment of the noise suppression method 500, candidate subscribers can be forced into the special half-duplex mode instead of a request. For example, the noise suppression method 500 can be implemented in a public safety context amongst first responders and the like. In these mission critical applications, it is important that first responders have an ability to communicate on the full-duplex communication channel. The noise suppression method 500 offers the request to noisy candidate subscribers such that it can be denied if the subscriber is a leader, incident commander, first on the scene, etc. and needs open access to the full-duplex communication channel. However, secondary responders may not have this same need and they may be automatically pushed into the special half-duplex mode based on their noise level. Of note, all subscribers can communicate regardless of their mode since the special half-duplex mode enables communication via PTT.

The noise suppression method 500 addresses the noise situation in any interconnect call, i.e. any many-to-many call such as a conference bridge, a group call, a webcast, or the like. Here, the bridge is measuring overall noise, deciding if the noise is higher than a certain threshold by amount of noise introduced. Accordingly, the bridge can decide which participants enter the special half-duplex device which can be enforced at the device or at the bridge to mute the line. In public safety, it is not possible to mute and prevent communication, hence the group communication systems and methods define the special half-duplex mode. This can be viewed as lying in between actual full-duplex and half-duplex modes. The bridge can decide where the noisiest source is and ask via an indication that look you are noisy and need move to a special half-duplex mode. When the user accepts, e.g. presses a special key, the user is preventing the stream from spreading to other users. All the streams are always open, the user is disabled either not sending to the bridge or being block by the bridge. For example, the bridge can still get the stream, but the stream is added to the full-duplex communication channel according to the PTT indication of the user. With conventional mute/unmute techniques, a line is either muted or unmuted depending on the current state. With the special half-duplex mode, the line is muted from the perspective that it is not added to the full-duplex communication channel unless a PTT indication is received, i.e. a special half-duplex mode line is added to the full-duplex communication channel as long as the PTT indication is active or enable such as by pressing a PTT button.

In an exemplary use case, the noise suppression method 500 can be used where the acoustic environment of one of far-end subscribers is very noisy and that noise is preventing the other subscribers to participate in the call. An example for this is when one of the subscribers is located in a very noisy environment so the subscriber's noisy stream would be added by the bridge to the others. In case of a high level noise this noise would take over the call, thus reducing the quality of the call or making it impossible. The problem can be aggravated by a number of noisy subscribers. Also, this is typical of public safety environments where subscribers may be on scene at an incident with significant levels of background noise.

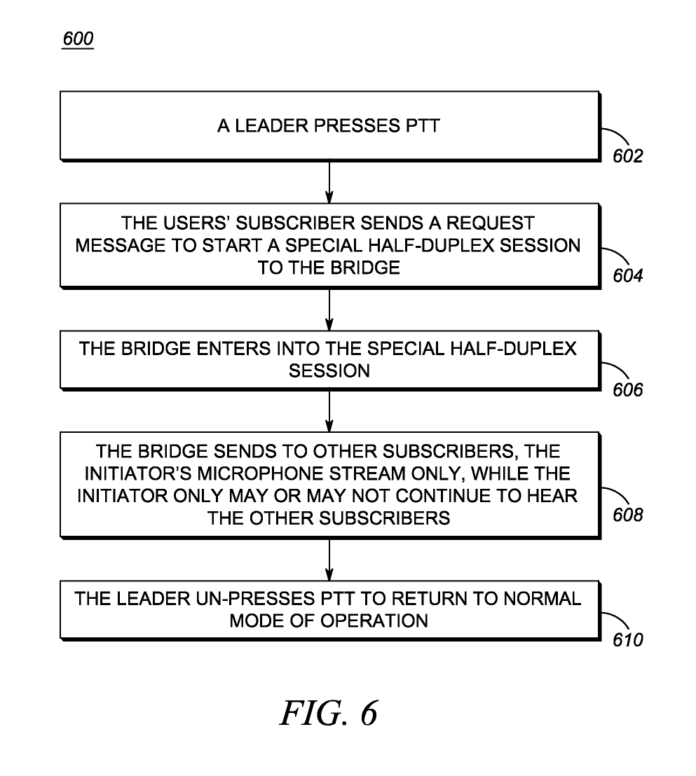

FIG. 6 is a flowchart of a leader imposed method 600 in group communication systems and methods in accordance with some embodiments. The leader imposed method 600 contemplates operation with the communication system 100, the interconnect system 400, and the like. In an exemplary embodiment, the leader imposed method 600 can be implemented by the server 102 and the user equipment 104, the bridge 410 and the subscriber 402, and the like. Also, the leader imposed method 600 can operate along with the noise suppression method 500. In the leader imposed method 600, a leader can press or enable PTT (step 602). For example, the leader imposed method 600 can be initiated at the user equipment 104 of the leader. The leader can be any party on a full-duplex communications channel that wants to intervene and take the floor while others are forced to listen. The leader can be, without limitation, an incident commander, a military leader, a chief executive, etc. The leader imposed method 600 enables one or more participants in an interconnect call to take the floor and lock others out in the special half-duplex mode or in a regular half-duplex mode.

Subsequent to the leader pressing the PTT, the users' subscriber sends a request message to start special half-duplex session to the bridge (step 604). Here, the leader is signaling via a device to the bridge to force all of the other subscribers into the special half-duplex session (or a regular half-duplex session). The bridge announces other subscribers about moving them to the special half-duplex mode such as via a visual notification and/or an audio notification. The bridge enters into the special half-duplex session (or a regular half-duplex session) (step 606). The bridge sends to other subscribers, the initiator's microphone stream only, while the initiator only may or may not continue to hear the other subscribers (step 608). Here, the leader may be able to still hear all subscribers or not, but the remaining subscribers can only hear the leader. The leader can un-press PTT to return to normal mode of operation (step 610).

In an exemplary embodiment, both the noise suppression method 500 and the leader imposed method 600 can be configured such that the bridge receives communications from all subscribers but only distributes the communications for subscribers in a full-duplex mode or in the special half-duplex mode with PTT enabled. In this manner, the bridge can record or preserve all communications for later use if needed. This aspect is especially useful in public safety situations where noise many be a distraction in real-time, but valuable for offline analysis of a particular situation. In this manner, real-time communications are preserved at higher quality while a full recording is preserved for later analysis.

Additionally, in the noise suppression method 500 and the leader imposed method 600, the special half-duplex mode does not simply mute a subscriber's line. Rather, the subscriber's line is available for communication via PTT, but not when PTT is disabled. In this manner, the group communication systems and methods are not simply muting/unmuting lines, but rather preserving the communication to the bridge but disabling the communication without PTT being enabled. Again, this is critical in public safety networks where anyone may need to communication. Here, the bridge is the device that knows how much noise is acceptable and how much noise is experienced. As such, each participant does not need to worry about their contribution to the noise but can focus on the communications. The bridge takes care of alerting individual candidate subscribers as needed.

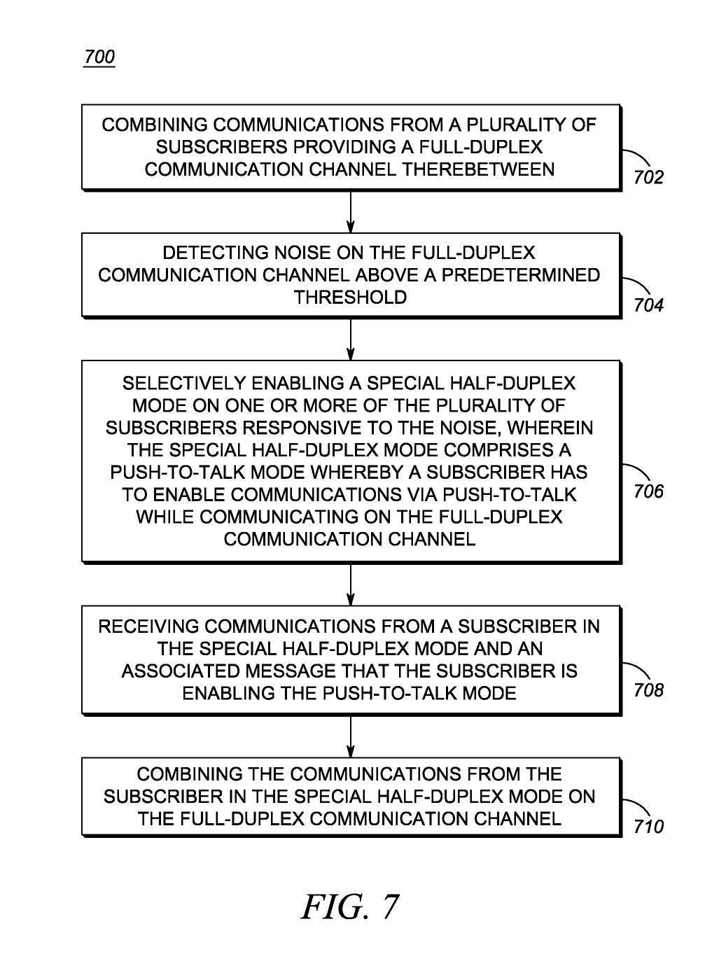

FIG. 7 is a flowchart of a group communication method 700 with noise suppression in accordance with some embodiments. The group communication method 700 contemplates operation with the communication system 100, the interconnect system 400, and the like. In an exemplary embodiment, the group communication method 700 can be implemented by the server 102, the bridge 410, and the like. The group communication method 700 also contemplates operation with the noise suppression method 500 and the leader imposed method 600. The group communication method 700 includes combining communications from a plurality of subscribers providing a full-duplex communication channel therebetween (step 702). For example, the subscribers can utilize the user equipment 104 in the communication system 100.

The group communication method 700 includes detecting noise on the full-duplex communication channel above a predetermined threshold (step 704). Again, the group communication method 700 can be implemented by a bridge which sees all communications and can determine noise for each subscriber and overall noise on the full-duplex communication channel. The group communication method 700 includes selectively enabling a special half-duplex mode on one or more of the plurality of subscribers responsive to the noise, wherein the special half-duplex mode comprises a push-to-talk mode whereby a subscriber has to enable communications via push-to-talk while communicating on the full-duplex communication channel (step 706). Again, the special half-duplex mode is not merely muting the subscriber's line, but rather a mode that sits between regular half-duplex and full-duplex where the subscriber can still communicate via PTT.

The group communication method 700 optionally includes receiving communications from a subscriber in the special half-duplex mode and an associated message that the subscriber is enabling the push-to-talk mode (step 708). As described herein, the bridge can receive messages that the push-to-talk (PTT) mode is enabled by a particular subscriber in the special half-duplex mode. The group communication method 700 optionally includes, responsive to the associated message that the subscriber is enabling the push-to-talk mode, combining the communications from the subscriber in the special half-duplex mode on the full-duplex communication channel (step 710).

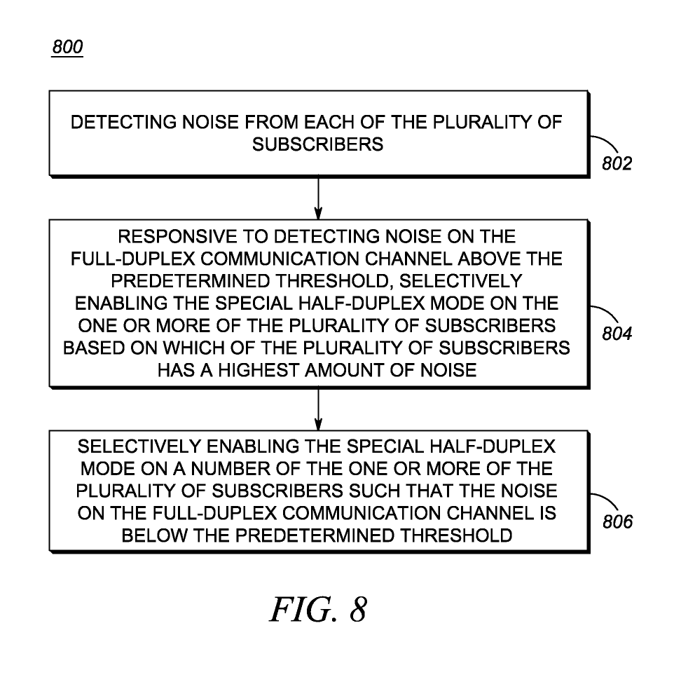

FIG. 8 is a flowchart of a noise detection method 800 for use with the group communication method 700 in accordance with some embodiments. The noise detection method 800 contemplates operation with the communication system 100, the interconnect system 400, and the like. In an exemplary embodiment, the noise detection method 800 can be implemented by the server 102, the bridge 410, and the like. The noise detection method 800 also contemplates operation with the noise suppression method 500 and the leader imposed method 600, and the noise detection method 800 specifically contemplates operation with the group communication method 700. The noise detection method 800 includes detecting noise from each of the plurality of subscribers (step 802). Again, the bridge has visibility to all subscribers, their noise, and the overall noise on the full-duplex communication channel.

The noise detection method 800 can include, responsive to detecting noise on the full-duplex communication channel above the predetermined threshold, selectively enabling the special half-duplex mode on the one or more of the plurality of subscribers based on which of the plurality of subscribers has a highest amount of noise (step 804). The noise detection method 800 can include selectively enabling the special half-duplex mode on a number of the one or more of the plurality of subscribers such that the noise on the full-duplex communication channel is below the predetermined threshold (step 806). Here, the noise detection method 800 can select more than one subscriber such that it maintains noise on the full-duplex communication channel below the predetermined threshold.

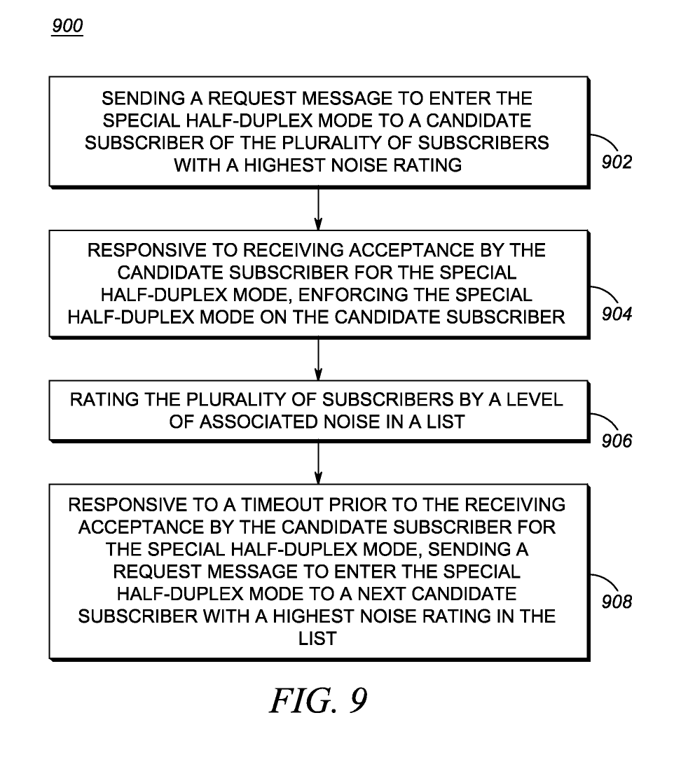

FIG. 9 is a flowchart of a selective enabling method 900 for use with the group communication method 700 in accordance with some embodiments. The selective enabling method 900 contemplates operation with the communication system 100, the interconnect system 400, and the like. In an exemplary embodiment, the selective enabling method 900 can be implemented by the server 102, the bridge 410, and the like. The selective enabling method 900 also contemplates operation with the noise suppression method 500, the leader imposed method 600, and the noise detection method 800, and the selective enabling method 900 specifically contemplates operation with the group communication method 700. The selective enabling method 900 includes sending a request message to enter the special half-duplex mode to a candidate subscriber of the plurality of subscribers with a highest noise rating (step 902).

The selective enabling method 900 includes, responsive to receiving acceptance by the candidate subscriber for the special half-duplex mode, enforcing the special half-duplex mode on the candidate subscriber (step 904). The selective enabling method 900 can include rating the plurality of subscribers by a level of associated noise in a list (step 906). The selective enabling method 900 can include, responsive to a timeout prior to the receiving acceptance by the candidate subscriber for the special half-duplex mode, sending a request message to enter the special half-duplex mode to a next candidate subscriber with a highest noise rating in the list (step 908). Optionally, the selective enabling method 900 can include repeating the sending and enforcing steps until the noise is below the predetermined threshold.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method, comprising:
combining communications from a plurality of subscribers providing a full-duplex communication channel therebetween;
detecting noise on the full-duplex communication channel above a predetermined threshold; and
selectively enabling a special half-duplex mode on one or more of the plurality of subscribers responsive to the noise, wherein the special half-duplex mode comprises a push-to-talk mode whereby a subscriber has to enable communications via push-to-talk while communicating on the full-duplex communication channel.

2. The method of claim 1, further comprising:
receiving communications from a subscriber in the special half-duplex mode and an associated message that the subscriber is enabling the push-to-talk mode; and
combining the communications from the subscriber in the special half-duplex mode on the full-duplex communication channel.

3. The method of claim 1, further comprising:
detecting noise from each of the plurality of subscribers; and
responsive to detecting noise on the full-duplex communication channel above the predetermined threshold, selectively enabling the special half-duplex mode on the one or more of the plurality of subscribers based on which of the plurality of subscribers has a highest amount of noise.

4. The method of claim 3, further comprising:
selectively enabling the special half-duplex mode on a number of the one or more of the plurality of subscribers such that the noise on the full-duplex communication channel is below the predetermined threshold.

5. The method of claim 1, wherein the special half-duplex mode is implemented in a bridge device having access to all inputs and outputs associated with the plurality of subscribers.

6. The method of claim 5, wherein the bridge device maintains a recording of all of the plurality of subscribers including subscribers in the special half-duplex mode.

7. The method of claim 1, wherein the selectively enabling comprises:
sending a request message to enter the special half-duplex mode to a candidate subscriber of the plurality of subscribers with a highest noise rating; and
responsive to receiving acceptance by the candidate subscriber for the special half-duplex mode, enforcing the special half-duplex mode on the candidate subscriber.

8. The method of claim 7, wherein the selectively enabling further comprises:
rating the plurality of subscribers by a level of associated noise in a list; and
responsive to a timeout prior to the receiving acceptance by the candidate subscriber for the special half-duplex mode, sending a request message to enter the special half-duplex mode to a next candidate subscriber with a highest noise rating in the list.

9. The method of claim 7, wherein the selectively enabling further comprises:
repeating the sending and enforcing steps until the noise is below the predetermined threshold.

10. The method of claim 1, further comprising:
detecting a request from a leader of the plurality of subscribers; and
responsive to the request, forcing each of the remaining plurality of subscribers into the special half-duplex mode.

11. The method of claim 10, further comprising:
subsequent to the forcing, providing the leader all communications of the full-duplex communication channel; and
providing the remaining plurality of subscribers communications only from the leader on the full-duplex communication channel.

12. A system, comprising:
a network interface communicatively coupled to a plurality of subscribers;
a processor communicatively coupled to the network interface; and
memory storing instructions that, when executed, cause the processor to:
combine communications from the plurality of subscribers providing a full-duplex communication channel therebetween;
detect noise on the full-duplex communication channel above a predetermined threshold; and
selectively enable a special half-duplex mode on one or more of the plurality of subscribers responsive to the detecting noise, wherein the special half-duplex mode comprises a push-to-talk mode whereby a subscriber has to enable communications via push-to-talk while communicating on the full-duplex communication channel.

13. The system of claim 12, wherein the instructions that, when executed, further cause the processor to
receive communications from a subscriber in the special half-duplex mode and an associated message that the subscriber is enabling the push-to-talk mode; and
combine the communications from the subscriber in the special half-duplex mode on the full-duplex communication channel.

14. The system of claim 12, wherein the instructions that, when executed, further cause the processor to
detect noise from each of the plurality of subscribers; and
responsive to detecting noise on the full-duplex communication channel above the predetermined threshold, selectively enable the special half-duplex mode on the one or more of the plurality of subscribers based on which of the plurality of subscribers has a highest amount of noise.

15. The system of claim 12, wherein the instructions that, when executed, further cause the processor to:
maintain a recording of all of the plurality of subscribers including subscribers in the special half-duplex mode.

16. The system of claim 12, wherein the instructions that, when executed, further cause the processor to:
send a request message to enter the special half-duplex mode to a candidate subscriber of the plurality of subscribers with a highest noise rating; and
responsive to receiving acceptance by the candidate subscriber for the special half-duplex mode, enforce the special half-duplex mode on the candidate subscriber.

17. The system of claim 16, wherein the instructions that, when executed, further cause the processor to:
rate the plurality of subscribers by a level of associated noise in a list; and
responsive to a timeout prior to the receiving acceptance by the candidate subscriber for the special half-duplex mode, send a request message to enter the special half-duplex mode to a next candidate subscriber with a highest noise rating in the list.

18. The system of claim 16, wherein the instructions that, when executed, further cause the processor to:
repeat the send and enforce steps until the noise is below the predetermined threshold.

19. A network, comprising:
a plurality of user equipment each associated with a subscriber; and
an interconnect system communicatively coupled to each of the plurality of user equipment;
wherein each of the plurality of user equipment is configured to participate in a full-duplex communication channel through the interconnect system; and
wherein the interconnect system is configured to:
combine communications from the plurality of user equipment providing the full-duplex communication channel therebetween;
detect noise on the full-duplex communication channel above a predetermined threshold or a request message from one of the plurality of user equipment; and
selectively enable a special half-duplex mode on one or more of the plurality of subscribers responsive to detecting noise or the request message, wherein the special half-duplex mode comprises a push-to-talk mode hereby a subscriber has to enable communications via push-to-talk while communicating on the full-duplex communication channel.
